(19) United States
(12) Patent Application Publication
(10) Pub. No.: US 2011/0237693 A1
(43) Pub. Date: Sep. 29, 2011

(54) Blends made of polyarylene ethers and of polyarylene sulfides

(75) Inventors: Martin Weber, Maikammer (DE); Christian Maletzko, Altrip (DE); Susanne Zeiher, Ludwigshafen (DE); Mark Völkel, Ladenburg (DE); Norbert Güntherberg, Speyer (DE); Rüdiger Bluhm, Limburgerhof (DE); Bernd Bruchmann, Freinsheim (DE)

(73) Assignee: BASF SE, Ludwigshafen (DE)

(21) Appl. No.: 13/053,872

(22) Filed: Mar. 22, 2011

Related U.S. Application Data
(60) Provisional application No. 61/316,397, filed on Mar. 23, 2010.

(51) Int. Cl. C08L 81/06; C08L 69/00; C08K 7/14; C08L 81/04

(52) U.S. Cl. 521/91; 525/462; 524/537; 521/134

(57) ABSTRACT

The present invention relates to thermoplastic molding compositions comprising the following components:
(A1) at least one polyarylene ether having an average of at most 0.5 phenolic end groups per polymer chain,
(A2) optionally at least one polyarylene ether having an average of at least 1.5 phenolic end groups per polymer chain,
(B) at least one polyarylene sulfide,
(C) at least one hyperbranched polymer selected from hyperbranched polycarbonates and hyperbranched polyesters,
(D) optionally at least one functionalized polyarylene ether comprising carboxy groups,
(E) optionally at least one fibrous or particulate filler, and
(F) optionally further additives and/or processing aids.

The present invention further relates to a process for producing the thermoplastic molding compositions of the invention, to the use of these for producing moldings, fibers, foams, or films, and to the resultant moldings, fibers, foams, and films.

The present invention relates to thermoplastic molding compositions comprising the following components:
(A1) at least one polyarylene ether having an average of at most 0.5 phenolic end groups per polymer chain,
(A2) optionally at least one polyarylene ether having an average of at least 1.5 phenolic end groups per polymer chain,
(B) at least, one polyarylene sulfide,
(C) at least one hyperbranched polymer selected from hyperbranched polycarbonates and hyperbranched polyesters,
(D) optionally at least one functionalized polyarylene ether comprising carboxy groups,
(E) optionally at least one fibrous or particulate filler, and
(F) optionally further additives and/or processing aids.

The present invention further relates to a process for producing the thermoplastic molding compositions of the invention, to the use of these for producing moldings, fibers, foams, or films, and to the resultant moldings, fibers, foams, and films.

Polyarylene ethers are engineering thermoplastics, and the high heat resistance and high chemical resistance of these materials leads to their use in very demanding applications. Polyarylene ethers are amorphous and therefore often have inadequate resistance to aggressive solvents. Polyarylene ethers also have high melt viscosity, and this is particularly disadvantageous for processing to give large moldings by means of injection molding. The high melt viscosity is particularly disadvantageous for producing molding compositions with high filler loading or high fiber loading.

Mixtures of high-temperature-resistant polyarylene ethers and polyarylene sulfides are known per se and, in comparison with the individual components, have by way of example improved mechanical properties and higher chemicals resistance.

EP-A 673 973 discloses glass fiber-filled polymer mixtures comprising polyarylene ether having at least 0.03% by weight of OH end groups, polyarylene ether having less than 0.03% by weight of OH end groups, and polyphenylene sulfide. The mechanical properties of the thermoplastic molding compositions of EP-A 673 973 are not adequate for all applications, and this applies in particular to tensile strain at break, ultimate tensile strength, and impact resistance, and also to modulus of elasticity. In particular, flowability is unsatisfactory.

EP-A 855 428 discloses rubber-containing polyarylene ethers which comprise functionalized polyarylene ethers that contain carboxy groups. The mechanical properties of the thermoplastic molding compositions of EP-A 855 428 are not adequate for all applications. In particular, flowability is unsatisfactory.

EP-A 903 376 relates to thermoplastic molding compositions comprising polyarylene ether, polyarylene sulfide, and rubber, where these likewise comprise functionalized polyarylene ethers. The functionalized polyarylene ethers used in EP-A 903 376 often have inadequate suitability for reinforced molding compositions. The use of these products in filled, in particular fiber-reinforced, molding compositions often leads to inadequate mechanical properties, in particular to inadequate toughness and ultimate tensile strength, and also to inadequate flowability.

Other features of the prior art are stiffness that is unsatisfactory for many applications, and a high degree of anisotropy in respect of stiffness (modulus of elasticity).

The object of the present invention therefore consisted in providing thermoplastic molding compositions which are based on polyarylene ethers and which do not have the abovementioned disadvantages or have these only to a smaller extent. In particular, the thermoplastic molding compositions should have improved flowability. At the same time, the thermoplastic molding compositions should have good mechanical properties, in particular high stiffness (modulus of elasticity), high impact resistance, high tensile strain at break, and high ultimate tensile strength. There should moreover be an improvement in anisotropy in respect of stiffness.

The abovementioned objects are achieved via the thermoplastic molding compositions of the invention. Preferred embodiments are found in the claims and in the description below. Combinations of preferred embodiments are within the scope of the present invention.

The thermoplastic molding compositions of the invention comprise the following components:
(A1) at least one polyarylene ether having an average of at most 0.5 phenolic end groups per polymer chain,
(A2) optionally at least one polyarylene ether having an average of at least 1.5 phenolic end groups per polymer chain,
(B) at least one polyarylene sulfide,
(C) at least one hyperbranched polymer selected from hyperbranched polycarbonates and hyperbranched polyesters,
(D) optionally at least one functionalized polyarylene ether comprising carboxy groups,
(E) optionally at least one fibrous or particulate filler, and
(F) optionally further additives and/or processing aids.

The thermoplastic molding compositions of the present invention preferably comprise the following components:
(A1) at least one polyarylene ether having an average of at most 0.5 phenolic end groups per polymer chain,
(A2) optionally at least one polyarylene ether having an average of at least 1.5 phenolic end groups per polymer chain,
(B) at least one polyarylene sulfide,
(C) at least one hyperbranched polymer selected from hyperbranched polycarbonates and hyperbranched polyesters,
(D) optionally at least one functionalized polyarylene ether comprising carboxy groups,
(E) at least one fibrous or particulate filler, and
(F) optionally further additives and/or processing aids.

The thermoplastic molding compositions of the present invention preferably comprise from 90 to 99.9% by weight of component (A1) and from 0.1 to 10% by weight of component (C), where the total of the % by weight values for components (A) and (C), based on the entire amount of components (A) and (C) is 100% by weight.

The thermoplastic molding compositions particularly preferably comprise:
from 20 to 89.9% by weight, in particular from 20 to 79.5% by weight, of component (A1),
from 0 to 10% by weight of component (A2),
from 5 to 65% by weight, in particular from 5 to 45% by weight, of component (B),
from 0.1 to 5% by weight, in particular from 0.5 to 3% by weight of component (C)
from 0 to 15% by weight, in particular from 0 to 10% by weight, of component (D),
from 5 to 70% by weight, in particular from 15 to 70% by weight, of component (E),
and
from 0 to 40% by weight, in particular from 0 to 20% by weight, of component (F),
   where the total of the % by weight values for components (A) to (F), based on the entire amount of components (A) to (F), is 100% by weight.

The thermoplastic molding compositions of the present invention very particularly preferably comprise
from 20 to 83.9% by weight, in particular from 20 to 73.5% by weight, of component (A1),
from 1 to 10% by weight of component (A2),
from 5 to 65% by weight, in particular from 5 to 45% by weight, of component (B),
from 0.1 to 5% by weight, in particular from 0.5 to 3% by weight, of component (C),
from 0 to 15% by weight, in particular from 0 to 10% by weight, of component (D),
from 10 to 70% by weight, in particular from 20 to 70% by weight, of component (F), and
from 0 to 40% by weight, in particular from 0 to 20% by weight, of component (F),
   where the total of the % by weight values for components (A) to (F), based on the entire amount of components (A) to (F), is 100% by weight.

The individual components are explained in more detail below.

Components A1 and A2

In the invention, the thermoplastic molding compositions comprise at least one polyarylene ether (A1) having an average of at most 0.5 phenolic end groups per polymer chain, and in one preferred embodiment moreover at least one polyarylene ether (A2) having an average of at least 1.5 phenolic end groups per polymer chain. The expression “an average” here means a number average. Components (A1) and (A2) are jointly termed component (A).

It is obvious to the person skilled in the art that the phenolic end groups are reactive, and can be present in at least to some extent reacted form within the thermoplastic molding compositions. The thermoplastic molding compositions are preferably produced via compounding, i.e. via mixing of the components in a flowable condition. Correspondingly the wording “thermoplastic molding compositions comprising the following components” is preferably considered equivalent to “thermoplastic molding compositions obtainable via compounding of the following components”.

For the purposes of the present invention, a phenolic end group is a hydroxy group bonded to an aromatic ring and also optionally in deprotonated form. The person skilled in the art is aware that a phenolic end group can also be present in the form of what is known as a phenolate end group by virtue of dissociation of a proton as a consequence of exposure to a base. The term phenolic end groups therefore expressly comprises not only aromatic OH groups but also phenolate groups.

The proportion of phenolic end groups is preferably determined via potentiometric titration. For this, the polymer is dissolved in dimethylformamide, and titrated with a solution of tetrabutylammonium hydroxide in toluene/methanol. The end point is determined by a potentiometric method. The proportion of halogen end groups is preferably determined by means of atomic spectroscopy.

The person skilled in the art can use known methods to determine the average number of phenolic end groups per polymer chain (n^{OH}), on the assumption of strictly linear polymer chains, using the following formula: n^{OH}=m^{OH} [in % by weight]/100*Mₙ^{P} [in g/mol]*1/17, starting from the proportion by weight of phenolic end groups, based on the total weight of the polymer (m^{OH}) and from the number-average molecular weight (Mₙ^{P}).

As an alternative, the average number of phenolic end groups per polymer chain (n^{OH}) can be calculated as follows: n^{OH}=2/(1+(17/35.45*m^{Cl}/m^{OH})) on the assumption that the end groups present are exclusively OH groups and Cl groups, and on the assumption of strictly linear polymer chains, if the proportion by weight of Cl end groups (m^{Cl}) is simultaneously known. The person skilled in the art knows how to adapt the calculation methods in the event that end groups other than Cl are present.

Without any intention of restriction, it is believed that the high content of reactive phenolic end groups in component (A2) causes the latter to act as compatibilizer for components (A) to (E). It is moreover believed that component (A1), which has high content of inert end groups, brings about a further improvement in the property profile of the thermoplastic molding compositions of the invention, the result being that the presence of polyarylene ethers having phenolic end groups on the one hand and of polyarylene ethers having inert end groups on the other hand has a synergistic effect in conjunction with components (C) and (D).

Production of polyarylene ethers with simultaneous control of the end groups is known to the person skilled in the art and is described in more detail at a later stage below. The known polyarylene ethers usually have halogen end groups, in particular —F or —Cl, or phenolic OH end groups or phenolate end groups, where the latter can be present as such or in reacted form, in particular in the form of —OCH₃ end groups.

It is preferable that the polyarylene ethers (A1) have at most 0.01% by weight, particularly at most 0.005% by weight, of phenolic end groups, based on the amount by weight of component (A1). It is preferable that the polyarylene ethers (A2) have at least 0.15% by weight, in particular at least 0.18% by weight, and particularly at least 0.2% by weight of phenolic end groups, based on the amount by weight of component (A2), in each case calculated in the form of amount by weight of OH.

In each case, the upper limit for the content of phenolic end groups in components (A1) and, respectively, (A2) is a function of the number of end groups available per molecule (two in the case of linear polyarylene ethers) and of the number-average chain length. The person skilled in the art is aware of corresponding calculations.

It is preferable that the average number of phenolic end groups of component (A1) per polymer chain is from 0 to 0.2, in particular from 0 to 0.1, particularly from 0 to 0.05, and very particularly from 0 to 0.02, and in particular at most 0.01.

If the thermoplastic molding compositions of the invention comprise a polyarylene ether (A2), the ratio by weight of component A1 to component A2 is preferably from 50:1 to 2:1, in particular from 25:1 to 5:1, particularly preferably from 20:1 to 10:1.

The average number of phenolic end groups of component (A2) per polymer chain is preferably from 1.6 to 2, in particular from 1.7 to 2, particularly preferably from 1.8 to 2, very particularly preferably from 1.9 to 2.

The polyarylene ethers (A1) and (A2) of the present invention can—except for the end groups—be identical or can be composed of different units and/or can have a different molecular weight, as long as they then remain completely miscible with one another.

If the thermoplastic molding compositions of the invention comprise a polyarylene ether (A2), it is preferable that the constituents (A1) and (A2) are structurally substantially similar, in particular being composed of the same units and having a similar molecular weight, where in particular the number-average molecular weight of one component is at most 30% greater than that of the other component.

Polyarylene ethers are a class of polymer known to the person skilled in the art. In principle, any of the polyarylene ethers that are known to the person skilled in the art and/or that can be produced by known methods can be used as constituent of component (A1) and optionally (A2). Corresponding methods are explained at a later stage below.

Preferred polyarylene ethers (A1) and optionally (A2) are those selected independently of one another from units of the general formula I:

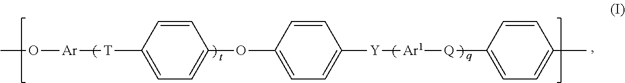

where the definitions of the symbols t, q, Q, T, Y, Ar and Ar¹ are as follows:
t, q: independently of one another 0, 1, 2, or 3,
Q, T, Y: independently of one another in each case a chemical bond or group selected from —O—, —S—, —SO₂—, S═O, C═O, —N═N—, and —CR^{a}R^{b}—, where R^{a} and R^{b} independently of one another are in each case a hydrogen atom or a C₁-C₁₂-alkyl, C₁-C₁₂-alkoxy, or C₆-C₁₈-aryl group, and where at least one of Q, T, and Y is —SO₂—, and
Ar, Ar¹: independently of one another an arylene group having from 6 to 18 carbon atoms.

If, within the abovementioned preconditions, Q, T or Y is a chemical bond, this then means that the adjacent group on the left-hand side and the adjacent group on the right-hand side are present with direct linkage to one another via a chemical bond.

However, it is preferable that Q, T, and Y in formula I are selected independently of one another from —O— and —SO₂—, with the proviso that at least one of the group consisting of Q, T, and Y is —SO₂—.

If Q, T, or Y is —CR^{a}R^{b}—, R^{a} and R^{b} independently of one another are in each case a hydrogen atom or a C₁-C₁₂-alkyl, C₁-C₁₂-alkoxy, or C₆-C₁₈-aryl group.

Preferred C₁-C₁₂-alkyl groups comprise linear and branched, saturated alkyl groups having from 1 to 12 carbon atoms. The following moieties may be mentioned in particular: C₁-C₆-alkyl moiety, e.g. methyl, ethyl, n-propyl, isopropyl, n-butyl, sec-butyl, 2- or 3-methylpentyl, and longer chain moieties, e.g. unbranched heptyl, octyl, nonyl, decyl, undecyl, lauryl, and the singly branched or multibranched analogs thereof.

Alkyl moieties that can be used in the abovementioned C₁-C₁₂-alkoxy groups that can be used are the alkyl groups defined at an earlier stage above having from 1 to 12 carbon atoms. Cycloalkyl moieties that can be used with preference in particular comprise C₃-C₁₂-cycloalkyl moieties, e.g. cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, cyclohexylmethyl, -dimethyl, and -trimethyl.

Ar and Ar¹ are independently of one another a C₆-C₁₈-arylene group. On the basis of the starting materials described at a later stage below, it is preferable that Ar derives from an electron-rich aromatic substance that is very susceptible to electrophilic attack, preferably selected from the group consisting of hydroquinone, resorcinol, dihydroxynaphthalene, in particular 2,7-dihydroxynaphthalene, and 4,4′-bisphenol. Ar¹ is preferably an unsubstituted C₆- or C₁₂-arylene group.

Particular C₆-C₁₈-arylene groups Ar and Ar¹ that can be used are phenylene groups, e.g. 1,2-, 1,3-, and 1,4-phenylene, naphthylene groups, e.g. 1,6-, 1,7-, 2,6-, and 2,7-naphthylene, and also the arylene groups that derive from anthracene, from phenanthrene, and from naphthacene.

In the preferred embodiment according to formula I, it is preferable that Ar and Ar¹ are selected independently of one another from the group consisting of 1,4-phenylene, 1,3-phenylene, naphthylene, in particular 2,7-dihydroxynaphthylene, and 4 ,4′-bisphenylene.

Preferred polyarylene ethers (A1) and (A2) are those which comprise at least one of the following structural repeat units Ia to Io:

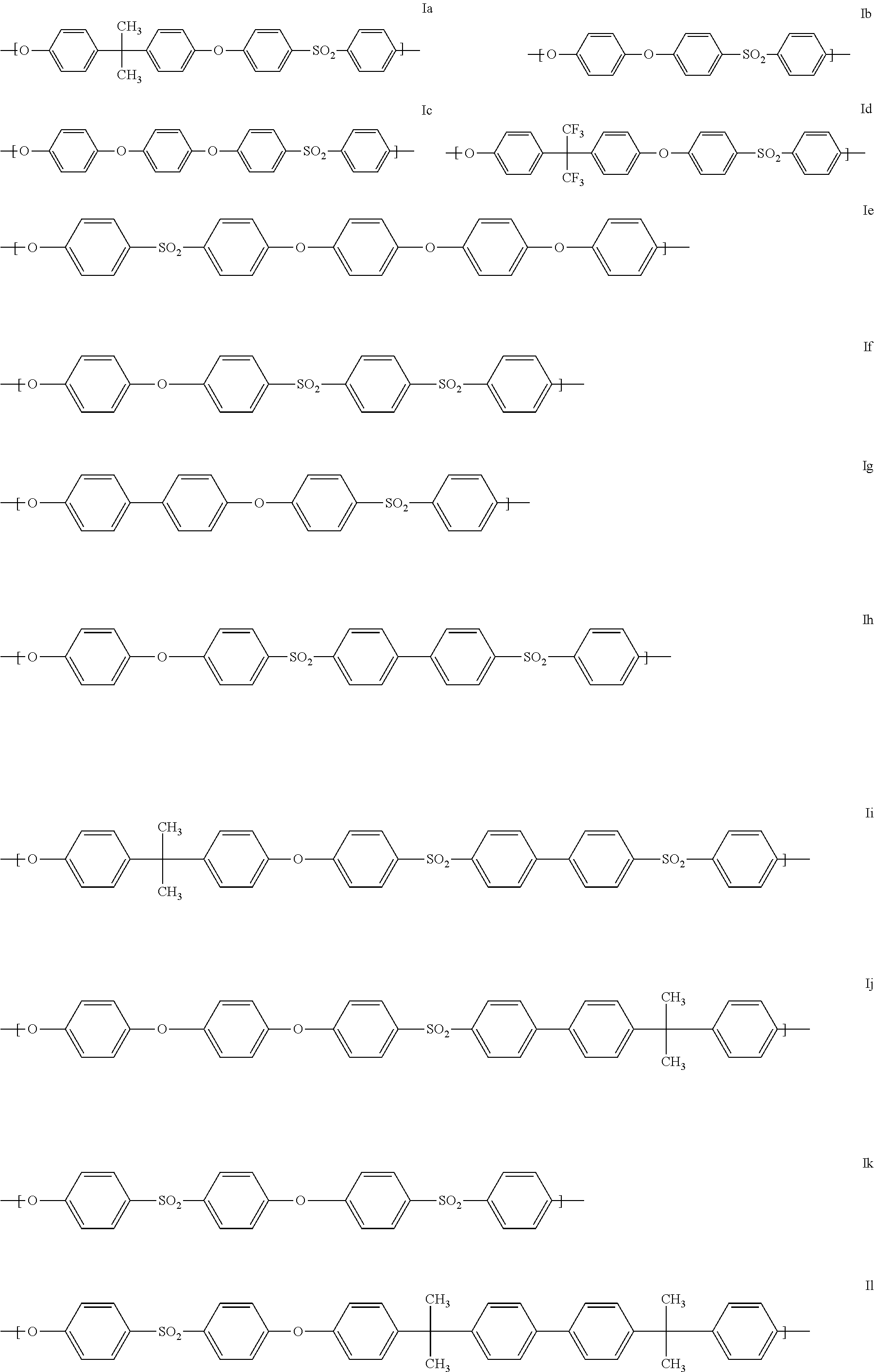

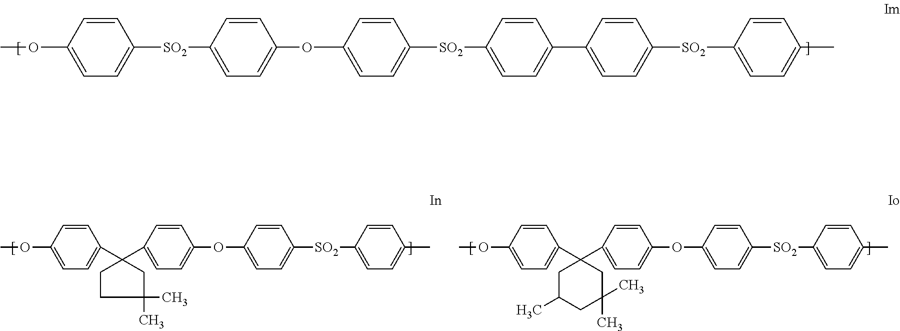

Other units to which preference is given, in addition to the preferred units Ia to Io, are those in which one or more 1,4-phenylene units deriving from hydroquinone have been replaced by 1,3-phenylene units deriving from resorcinol, or by naphthylene units deriving from dihydroxynaphthalene.

Particularly preferred units of the general formula I are the units Ia, Ig, and Ik. It is also particularly preferable that the polyarylene ethers of component (A1) and optionally (A2) are in essence composed of one type of unit of the general formula I, in particular of one unit selected from Ia, Ig, and Ik.

In one particularly preferred embodiment, Ar=1,4-phenylene, t=1, q=0, T is a chemical bond, and Y═SO₂. Particularly preferred polyarylene ether sulfones (A1) and, respectively, (A2) composed of the abovementioned repeat unit are termed polyphenylene sulfone (PPSU).

In another particularly preferred embodiment, Ar=1,4-phenylene, t=1, q=0, T=C(CH₃)₂, and Y═SO₂. Particularly preferred polyarylene ether sulfones (A1) and, respectively, (A2) composed of the abovementioned repeat unit are termed polysulfone (PSU).

In another particularly preferred embodiment, Ar=1,4-phenylene, t=1, q=0, T=Y═SO₂. Particularly preferred polyarylene ether sulfones (A1) and, respectively, (A2) composed of the abovementioned repeat unit are termed polyether sulfone (PESU). This embodiment is very particularly preferred.

For the purposes of the present invention, abbreviations such as PPSU, PESU, and PSU are in accordance with DIN EN ISO 1043-1:2001.

The average molar masses Mₙ (number average) of the preferred polyarylene ethers (A1) and optionally (A2) are generally in the range from 5000 to 60 000 g/mol, with relative viscosities of from 0.20 to 0.95 dl/g. The relative viscosities of the polyarylene ethers are determined in 1% strength by weight N-methylpyrrolidone solution at 25° C. to DIN EN ISO 1628-1.

The weight-average molar masses M_{w} of the polyarylene ethers (A1) and optionally (A2) of the present invention are preferably from 10 000 to 150 000 g/mol, in particular from 15 000 to 120 000 g/mol, particularly preferably from 18 000 to 100 000 g/mol, determined by means of gel permeation chromatography in dimethylacetamide solvent against narrowly distributed polymethyl methacrylate as standard.

Production processes that lead to the abovementioned polyarylene ethers are known per se to the person skilled in the art and are described by way of example in Herman F. Mark, “Encyclopedia of Polymer Science and Technology”, third edition, volume 4, 2003, “Polysulfones” chapter, pages 2 to 8, and also in Hans R. Kricheldorf, “Aromatic Polyethers” in: Handbook of Polymer Synthesis, second edition, 2005, pages 427 to 443.

Particular preference is given to the reaction, in aprotic polar solvents and in the presence of anhydrous alkali metal carbonate, in particular sodium carbonate, potassium carbonate, calcium carbonate, or a mixture thereof, very particularly preferably potassium carbonate, between at least one aromatic compound having two halogen substituents and at least one aromatic compound having two functional groups reactive toward abovementioned halogen substituents. One particularly suitable combination is N-methylpyrrolidone as solvent and potassium carbonate as base.

It is preferable that the polyarylene ethers (A1) have either halogen end groups, in particular chlorine end groups, or etherified end groups, in particular alkyl ether end groups, these being obtainable via reaction of the OH or, respectively, phenolate end groups with suitable etherifying agents.

Examples of suitable etherifying agents are monofunctional alkyl or aryl halide, e.g. C₁-C₆-alkyl chloride, C₁-C₆-alkyl bromide, or C₁-C₆-alkyl iodide, preferably methyl chloride, or benzyl chloride, benzyl bromide, or benzyl iodide, or a mixture thereof. For the purposes of the polyarylene ethers of component (A1) preferred end groups are halogen, in particular chlorine, alkoxy, in particular methoxy, aryloxy, in particular phenoxy, or benzyloxy.

Production of the polyarylene ethers (A2) is discussed below. A preferred process for producing polyarylene ethers of component (A2) is described hereinafter and comprises the following steps in the sequence a-b-c:
(a) provision of at least one polyarylene ether (A2*) in the presence of a solvent (S), where the content of phenolic end groups in this polyarylene ether is appropriate for the desired component (A2), where the phenolic end groups thereof are present in the form of phenolate end groups, and this polyarylene ether is preferably composed of units of the general formula I as defined above,
(b) addition of at least one acid, preferably of at least one polybasic carboxylic acid, and
(c) obtaining the polyarylene ethers of component (A2) in the form of solid.

The polyarylene ether (A2*) is preferably provided here in the form of a solution in the solvent (S).

There are in principle various ways of providing the polyarylene ethers (A2*) described. By way of example, an appropriate polyarylene ether (A2*) can be brought directly into contact with a suitable solvent and directly used in the process of the invention, i.e. without further reaction. As an alternative, prepolymers of polyarylene ethers can be used and reacted in the presence of a solvent, whereupon the polyarylene ethers (A2*) described are produced in the presence of the solvent.

However, the polyarylene ether(s) (A2*) is/are preferably provided in step (a) via reaction of at least one starting compound of structure X—Ar—Y (s1) with at least one starting compound of structure HO—Ar¹—OH (s2) in the presence of a solvent (S) and of a base (B), where
Y is a halogen atom,
X is selected from halogen atoms and OH, and
Ar and Ar¹ independently of one another are an arylene group having from 6 to 18 carbon atoms.

The ratio of (s1) and (s2) here is selected in such a way as to produce the desired content of phenolic end groups. Suitable starting compounds are known to the person skilled in the art or can be produced by known methods.

Hydroquinone, resorcinol, dihydroxynaphthalene, in particular 2,7-dihydroxynaphthalene, 4,4′-dihydroxydiphenyl sulfone, bisphenol A, and 4,4′-dihydroxybiphenyl are particularly preferred as starting compound (s2).

However, it is also possible to use trifunctional compounds. In this case, branched structures are produced. If a trifunctional starting compound (s2) is used, preference is given to 1,1,1-tris(4-hydroxyphenyl)ethane.

The quantitative proportions to be used are in principle a function of the stoichiometry of the polycondensation reaction that proceeds, with cleavage of the theoretical amount of hydrogen chloride, and the person skilled in the art adjusts these in a known manner. However, an excess of (s2) is preferable, in order to increase the number of phenolic OH end groups.

In this embodiment, the molar (s2)/(s1) ratio is particularly preferably from 1.005 to 1.2, in particular from 1.01 to 1.15, and very particularly preferably from 1.02 to 1.1.

As an alternative, it is also possible to use a starting compound (s1) having X=halogen and Y═OH. In this case, an excess of hydroxy groups is achieved via addition of the starting compound (s2). In this case, the ratio of the phenolic end groups used to halogen is preferably from 1.01 to 1.2, in particular from 1.03 to 1.15, and very particularly preferably from 1.05 to 1.1.

It is preferable that the conversion in the polycondensation reaction is at least 0.9, so as to provide an adequately high molecular weight. If a prepolymer is used as precursor of the polyarylene ether, the degree of polymerization is based on the number of actual monomers.

Preferred solvents (S) are aprotic polar solvents. The boiling point of suitable solvents is moreover in the range from 80 to 320° C., in particular from 100 to 280° C., preferably from 150 to 250° C. Examples of suitable aprotic polar solvents are high-boiling ethers, esters, ketones, asymmetrically halogenated hydrocarbons, anisole, dimethylformamide, dimethyl sulfoxide, sulfolan, N-ethyl-2-pyrrolidone, and N-methyl-2-pyrrolidone.

The reaction of the starting compounds (s1) and (s2) preferably takes place in the abovementioned aprotic polar solvents (S), in particular N-methyl-2-pyrrolidone.

The person skilled in the art knows per se that the reaction of the phenolic OH groups preferably takes place in the presence of a base (B), in order to increase reactivity with respect to the halogen substituents of the starting compound (s1).

It is preferable that the bases (B) are anhydrous. Particularly suitable bases are anhydrous alkali metal carbonate, preferably sodium carbonate, potassium carbonate, calcium carbonate, or a mixture thereof, and very particular preference is given here to potassium carbonate.

A particularly preferred combination is N-methyl-2-pyrrolidone as solvent (S) and potassium carbonate as base (B).

The reaction of the suitable starting compounds (s1) and (s2) is carried out at a temperature of from 80 to 250° C., preferably from 100 to 220° C., and the boiling point of the solvent provides an upper restriction on the temperature here. The reaction preferably takes place within a period of from 2 to 12 h, in particular from 3 to 8 h.

It has proven advantageous, after step (a) and prior to execution of step (b), to filter the polymer solution. This removes the salt formed during the polycondensation reaction, and also any gel that may have formed.

It has also proven advantageous for the purposes of step (a) to adjust the amount of the polyarylene ether (A2*), based on the total weight of the mixture of polyarylene ether (A2*) and solvent (S) to from 10 to 70% by weight, preferably from 15 to 50% by weight.

For the purposes of step (b), at least one acid is added, preferably at least one polybasic carboxylic acid, to the polyarylene ether (A2*) from step (a), preferably to the solution of the polyarylene ether (A2*) in the solvent (S).

“Polybasic” means a basicity of at least 2. The basicity is the (optionally average) number of COOH groups per molecule. Polybasic means basicity of two or higher. For the purposes of the present invention, preferred carboxylic acids are dibasic and tribasic carboxylic acids.

The polybasic carboxylic acid can be added in various ways, in particular in solid or liquid form or in the form of a solution, preferably in a solvent miscible with the solvent (S).

The number-average molar mass of the polybasic carboxylic acid is preferably at most 1500 g/mol, in particular at most 1200 g/mol. At the same time, the number-average molar mass of the polybasic carboxylic acid is preferably at least 90 g/mol.

Particularly suitable polybasic carboxylic acids are those according to the general structure II:

HOOC—R—COOH (II),

where R represents a hydrocarbon moiety having from 2 to 20 carbon atoms and optionally comprising further functional groups, preferably selected from OH and COOH.

Preferred polybasic carboxylic acids are C₄-C₁₀ dicarboxylic acids, in particular succinic acid, glutaric acid, adipic acid, and tricarboxylic acids, in particular citric acid. Particularly preferred polybasic carboxylic acids are succinic acid and citric acid.

In order to provide adequate conversion of the phenolate end groups to phenolic end groups, it has proven advantageous to adjust the amount of the polybasic carboxylic acid(s) used in respect of the amount of the phenolate end groups.

For the purposes of step (b) it is preferable to add a polybasic carboxylic acid so that the amount of carboxy groups is from 25 to 200 mol %, preferably from 50 to 150 mol %, particularly preferably from 75 to 125 mol %, based on the molar amount of phenolic end groups.

If the amount of acid added is too small, the precipitation properties of the polymer solution are inadequate, while any markedly excessive addition can cause discoloration of the product during further processing.

For the purposes of step (c), the polyarylene ether (A2) is obtained in the form of solid. In principle, various processes can be used for obtaining the material in the form of solid. However, it is preferable to obtain the polymer composition via precipitation.

The preferred precipitation process can in particular take place via mixing of the solvent (S) with a poor solvent (S′). A poor solvent is a solvent in which the polymer composition is not soluble. This poor solvent is preferably a mixture of a non-solvent and a solvent. A preferred non-solvent is water. A preferred mixture (S′) of a solvent with a non-solvent is preferably a mixture of the solvent (S), in particular N-methyl-4-pyrrolidone, and water. It is preferable that the polymer solution from step (b) is added to the poor solvent (S′), the result being precipitation of the polymer composition. It is preferable here to use an excess of the poor solvent. It is particularly preferable that the polymer solution from step (a) is added in finely dispersed form, in particular in droplet form.

If the poor solvent (S′) used comprises a mixture of the solvent (S), in particular N-methyl-2-pyrrolidone, and of a non-solvent, in particular water, a preferred solvent:non-solvent mixing ratio is then from 1:2 to 1:100, in particular from 1:3 to 1:50.

A mixture of water and N-methyl-2-pyrrolidone (NMP) in combination with N-methyl-2-pyrrolidone as solvent (S) is preferred as poor solvent (S′). An NMP/water mixture in the ratio of from 1:3 to 1:50, in particular 1:30, is particularly preferred as poor solvent (S′).

The precipitation process is particularly efficient when the content of the polymer composition in the solvent (S), based on the total weight of the mixture of polymer composition and solvent (S), is from 10 to 50% by weight, preferably from 15 to 35% by weight.

The potassium content of component (A2) is preferably at most 600 ppm. The potassium content is determined by means of atomic spectrometry.

Component B

The molding compositions of the invention comprise, as component (B), at least one polyarylene sulfide. In principle, any of the polyarylene sulfides can be used as component (B).

The amounts of component (B) present in the thermoplastic molding compositions of the invention are preferably from 5 to 65% by weight, particularly preferably from 5 to 45% by weight, in particular from 5 to 30% by weight, very particularly preferably from 10 to 20% by weight, based in each case on the total amount of components (A) to (F).

The polyarylene sulfides of component (B) are preferably composed of from 30 to 100% by weight of repeat units according to the general formula —Ar—S—, where —Ar— is an arylene group having from 6 to 18 carbon atoms.

Preference is given to polyarylene sulfides which comprise, based on the total weight of all repeat units, at least 30% by weight, in particular at least 70% by weight, of repeat units III:

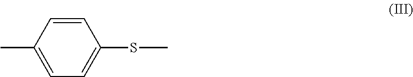

Particularly suitable other repeat units are

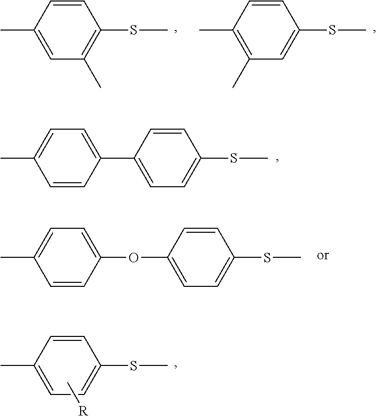

in which R is C₁-C₁₀-alkyl, preferably methyl. The polyarylene sulfides can be homopolymers, random copolymers, or block copolymers, preference being given here to homopolymers (identical repeat units). Very particularly preferred polyarylene sulfides are composed of 100% by weight of repeat units according to the general formula III. Component (B) is therefore particularly preferably a polyphenylene sulfide, in particular poly(l,4-phenylene sulfide).

End groups that can be used in the polyarylene sulfides used according to the invention are in particular halogen, thiol, or hydroxy, preferably halogen.

The polyarylene sulfides of component (B) can be branched or unbranched compounds. The polyarylene sulfides of component (B) are preferably linear, i.e. not branched.

The weight-average molar masses of the polyarylene sulfides of component (B) are preferably from 5000 to 100 000 g/mol.

Polyarylene sulfides of this type are known per se or can be produced by known methods. Appropriate production methods are described by way of example in Hans R. Kricheldorf, “Aromatic Polyethers” in: Handbook of Polymer Synthesis, second edition, 2005, pages 486 to 492.

They can in particular, as described in U.S. Pat. No. 2,513,188, be produced via reaction of haloaromatics with sulfur or with metal sulfides. It is equally possible to heat metal salts of halogen-substituted thiophenols (see GB-B 962 941). Among the preferred syntheses of polyarylene sulfides is the reaction of alkali metal sulfides with haloaromatics in solution, for example as found in U.S. Pat. No. 3,354,129, U.S. Pat. No. 3,699,087 and U.S. Pat. No. 4,645,826 describe further processes.

Component C

In the invention, the thermoplastic molding compositions comprise, as component (C), at least one hyperbranched polymer selected from hyperbranched polycarbonates and hyperbranched polyesters.

The molding compositions of the invention preferably comprise from 0.1 to 10% by weight, in particular from 0.1 to 5% by weight, and particularly preferably from 0.5 to 3% by weight, of component (C), based on the entire amount of components (A) to (F).

For the purposes of the present invention, the meaning of the term “hyperbranched” is that the degree of branching DB of the relevant polymers, defined as DB (%)=100×(T+Z)/(T+Z+L), where T is the average number of terminally bonded monomer units, Z is the average number of monomer units forming branching systems, and L is the average number of linearly bonded monomer units in the macromolecules of the respective substances, is from 10 to 99%, preferably from 25 to 90%, and particularly preferably from 30 to 80%. For the purposes of the present invention, the term “hyperbranched” is used synonymously with “highly branched”. Hyperbranched polymers must not be confused with dendrimers. For the definition of “degree of branching”, see H. Frey et al., Acta Polym. 1997, 48, 30. For the definition of the term “hyperbranched”, see Sunder et al., Chem. Eur. J. 2000, 6 (14), 2499-2506.

Dendrimers are polymers having a perfectly symmetrical structure, and can be produced by starting from a central molecule and using controlled stepwise linkage of respectively two or more di- or polyfunctional monomers to each previously bonded monomer. Every linkage step here multiplies the number of monomer end groups (and therefore the number of linkages), and the products are polymers having tree-like structures, ideally spherical, where each of the branches comprises exactly the same number of monomer units. By virtue of said perfect structure, the properties of the polymer are often advantageous, examples observed being low viscosity and high reactivity, due to the large number of functional groups at the surface of the sphere. However, a factor that complicates the production process is that every linkage step requires introduction and, in turn, removal of protective groups, and purification operations are required, and for this reason it is usual to produce dendrimers only on a laboratory scale.

However, hyperbranched polymers can be produced by large-scale industrial processes. Hyperbranched polymers have not only perfect dendritic structures but also linear polymer chains and unequal polymer branches, but this does not significantly impair the properties of the polymer in comparison with those of perfect dendrimers. Hyperbranched polymers can in particular be produced by way of two synthetic routes, known as AB₂ and Aₓ+B_{y}. A and B here represent different monomer units, and the indices x and y represent the number of reactive functional groups comprised in A and, respectively, B, i.e. the functionality of A and, respectively, B. In the AB₂ route, a trifunctional monomer having one reactive group A and two reactive groups B is reacted to give a highly branched or hyperbranched polymer. In the Aₓ and B_{y} synthesis, taking the example of the A₂+B₃ synthesis, a difunctional monomer A₂ is reacted with a trifunctional monomer B₃. This initially gives a 1:1 adduct made of A and B having an average of one functional group A and two functional groups B, and this can then likewise react to give a hyperbranched polymer.

The hyperbranched (non-dendrimeric) polymers used in the invention differ from dendrimers in the degree of branching defined above. In the context of the present invention, the polymers are “dendrimeric” when their degree of branching DB is from 99.9 to 100%. A dendrimer therefore has the maximum possible number of branching points, this number being achievable only by virtue of a highly symmetrical structure.

Preferred hyperbranched polycarbonates have an OH number of from 1 to 600 mg KOH/g of polycarbonate, preferably from 10 to 550 mg KOH/g of polycarbonate, and in particular from 50 to 550 mg KOH/g of polycarbonate (to DIN 53240, part 2), and are hereinafter termed hyperbranched polycarbonates C1).

Preferred hyperbranched polyesters are those of Aₓ B_{y} type, where A and B characterize different monomer units and x is at least 1, in particular at least 1.1, and y is at least 2, in particular at least 2.1, and are hereinafter termed hyperbranched polyesters C2).

For the purposes of this invention, hyperbranched polycarbonates C1) are uncrosslinked macromolecules having hydroxy and carbonate groups and having both structural and molecular nonuniformity. They can firstly be composed of a central molecule by analogy with dendrimers, but with nonuniform chain lengths of the branches. Secondly, they can also be of linear structure, having functional pendent groups, or else, combining the two extremes, can have linear and branched portions of the molecule.

The number-average molar mass Mn of the preferred hyperbranched polycarbonates C1) is preferably from 100 to 15 000 g/mol, preferably from 200 to 12 000 g/mol, and in particular from 500 to 10 000 g/mol (GPC, PMMA standard). The glass transition temperature Tg is in particular from −80° C. to +140, preferably from −60 to 120° C. (by DSC, DIN 53765). Viscosity at 23° C. (to DIN 53019) is in particular from 50 to 200 000 mPas, in particular from 100 to 150 000 mPas, and very particularly preferably from 200 to 100 000 mPas.

Hyperbranched polycarbonates are known per se or can be produced by methods known per se.

Hyperbranched polycarbonates C1) are preferably obtainable via a process which comprises at least the following steps:
alternative aa) reaction of at least one organic carbonate (G) of the general formula RO[(CO)]ₙOR with at least one aliphatic, aliphatic/aromatic, or aromatic alcohol (H) which has at least 3 OH groups, with elimination of alcohols ROH to give one or more condensates (K), where each R independently of the others is a straight-chain or branched aliphatic, aromatic/aliphatic, or aromatic hydrocarbon radical having from 1 to 20 carbon atoms, and where the radicals R can also have bonding to one another to form a ring, and n is an integer from 1 to 5, or
alternative ab) reaction of phosgene, diphosgene, or triphosgene with abovementioned alcohol (H) with elimination of hydrogen chloride, and also, subsequent to aa) and, respectively, ab),
intermolecular reaction of the condensates (K) to give a high-functionality, highly branched or hyperbranched polycarbonate,
   where the quantitative proportion of the OH groups with respect to the carbonates in the reaction mixture is selected in such a way that the condensates (K) have an average of either one carbonate group and more than one OH group or one OH group and more than one carbonate group.

The starting material used can comprise phosgene, diphosgene, or triphosgene, but preference is given here to organic carbonates.

Each of the radicals R of the organic carbonates (G) used as starting material and having the general formula RO(CO)ₙOR is independently of the others a straight-chain or branched aliphatic, aromatic/aliphatic, or aromatic hydrocarbon radical having from 1 to 20 carbon atoms. The two radicals R can also have bonding to one another to form a ring. Preference is given to an aliphatic hydrocarbon radical and particular preference is given to a straight-chain or branched alkyl radical having from 1 to 5 carbon atoms, or a substituted or unsubstituted phenyl radical.

In particular, simple carbonates of the formula RO(CO)ₙOR are used; n is preferably from 1 to 3, in particular 1.

Corresponding dialkyl or diaryl carbonates are known and can by way of example be produced from the reaction of aliphatic, araliphatic, or aromatic alcohols, preferably monoalcohols, with phosgene. They can also be produced via oxidative carbonylation of the alcohols or phenols by means of CO in the presence of noble metals, oxygen, or NOₓ. For methods used to produce diaryl or dialkyl carbonates, see also “Ullmann's Encyclopedia of Industrial Chemistry”, 6th Edition, 2000 Electronic Release, Verlag Wiley-VCH.

Examples of suitable carbonates comprise aliphatic, aromatic/aliphatic, or aromatic carbonates, such as ethylene carbonate, 1,2- or 1,3-propylene carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates in which n is greater than 1 comprise dialkyl dicarbonates, such as di(t-butyl) dicarbonate, or dialkyl tricarbonates, such as di(t-butyl) tricarbonate. It is preferable to use aliphatic carbonates, in particular those in which the radicals comprise from 1 to 5 carbon atoms, examples being dimethyl carbonate, diethyl carbonate, dipropyl carbonate, dibutyl carbonate, and diisobutyl carbonate.

The organic carbonates (G) are reacted with at least one aliphatic alcohol (H) which has at least 3 OH groups, or with a mixture of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl)isocyanurate, tris(hydroxyethyl)isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, or sugars, e.g. glucose, tri- or polyfunctional polyetherols based on alcohols of functionality three or higher and ethylene oxide, propylene oxide, or butylene oxide, or polyesterols. Particular preference is given here to glycerol, trimethylolethane, trimethylolpropane, 1,2,4-butanetriol, and pentaerythritol, and also to polyetherols of these based on ethylene oxide or propylene oxide.

Said polyfunctional alcohols can also be used in a mixture with difunctional alcohols (H′), with the proviso that the average overall OH functionality of all of the alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3,5-trimethylcyclohexane, resorcinol, hydroquinone, 4,4′-dihydroxyphenyl, bis(4-bis(hydroxyphenyl)sulfide, bis(4-hydroxyphenyl)sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxybenzophenone, difunctional polyether polyols based on ethylene oxide, propylene oxide, butylene oxide, or a mixture of these, polytetrahydrofuran, polycaprolactone, or polyesterols based on diols and dicarboxylic acids.

The diols serve for fine adjustment of the properties of the polycarbonates. If difunctional alcohols are used, the ratio of difunctional alcohols H′) to the at least trifunctional alcohols (H) is established by the person skilled in the art as a function of the properties desired in the polycarbonate. The amount of the alcohol(s) (H′) used is generally from 0 to 39.9 mol %, based on the total amount of all of the alcohols (H) and (H′). The amount is preferably from 0 to 35 mol %, particularly preferably from 0 to 25 mol %, and very particularly preferably from 0 to 10 mol %.

The reaction of phosgene, diphosgene, or triphosgene with the alcohol or alcohol mixture generally takes place with elimination of hydrogen chloride, and the reaction of the carbonates with the alcohol or alcohol mixture to give the high-functionality hyperbranched polycarbonate of the invention takes place with elimination of the monofunctional alcohol or phenol from the carbonate molecule.

The high-functionality hyperbranched polycarboantes C1) formed by the preferred process have termination by hydroxy groups and/or by carbonate groups after the reaction, i.e. without further modification. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a high-functionality polycarbonate is a product which also has, alongside the carbonate groups which form the main structure of the polymer, at least three, preferably at least six, more preferably at least ten, terminal or pendent functional groups. The functional groups are carbonate groups and/or OH groups. The number of terminal or pendent functional groups is not in principle subject to any upward restriction, but products having a very large number of functional groups can have unwanted properties, such as high viscosity or poor solubility. The high-functionality polycarbonates of the present invention mostly have no more than 500 terminal or pendent functional groups, preferably no more than 100 terminal or pendent functional groups.

In producing the high-functionality polycarbonates C1) it is necessary to set the ratio of the compounds comprising OH groups to phosgene or carbonate in such a way that the simplest resultant condensate (hereinafter termed condensate (K)) has an average of either one carbonate group or carbamoyl group and more than one OH group or one OH group and more than one carbonate group or carbamoyl group. The simplest arrangement here in the structure of the condensate (K) derived from a carbonate (G) and from a di- or polyalcohol is XYₙ or YₙX, where X is a carbonate group, Y is a hydroxy group, and n is generally a number from 1 to 6, preferably from 1 to 4, particularly preferably from 1 to 3. The reactive group which is the resultant single group is generally termed “focal group” hereinafter.

Corresponding reactions of carbonates (G) with di- or polyalcohols using various reaction ratios and optionally in the presence of additional difunctional compounds as chain extenders are known and are disclosed by way of example in WO 2008/074687, from line 29 on page 13 to line 12 on page 18, and the content of that document is hereby expressly incorporated by way of reference.

Because of the nature of the condensates (K) it is possible that the condensation reaction can give polycondensates (P) having different structures, where these have branching systems but no crosslinking. Ideally the polycondensates (P) moreover have either one carbonate group as focal group and more than two OH groups or else one OH groups as focal group and more than two carbonate groups. The number of reactive groups here is the result of the nature of the condensates (K) used and of the degree of polycondensation.

In another preferred embodiment, the preferred polycarbonates C1) can comprise further functional groups alongside the functional groups intrinsically obtained via the reaction. This functionalization can take place during the process of increasing molecular weight or else subsequently, i.e. after conclusion of the actual polycondensation process.

If, prior to or during the process of increasing molecular weight, components are added which have further functional groups alongside hydroxy or carbonate groups, or which possess functional elements, the product is a polycarbonate polymer having randomly distributed functionalities that differ from the carbonate or hydroxy groups.

Effects of this type can by way of example be obtained via addition of compounds during the polycondensation process, where these bear not only hydroxy groups, carbonate groups, or carbamoyl groups, but also further functional groups or functional elements, examples being mercapto groups, primary, secondary, or tertiary amino groups, ether groups, silane groups, siloxane groups, aryl radicals or long-chain alkyl radicals, or derivatives of carboxylic acids or derivatives of sulfonic acids or derivatives of phosphonic acids. Examples of compounds that can be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol, or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine, or isophoronediamine.

For the modification process using mercapto groups, mercaptoethanol can be used, for example. Tertiary amino groups can be produced by way of example via incorporation of N-methyldiethanolamine, N-methyldipropanolamine, or N,N-dimethylethanolamine. Ether groups can be generated by way of example via a condensation process that includes di- or polyfunctional polyetherols. Reaction with long-chain alkanediols can be used to introduce long-chain alkyl radicals and reaction with alkyl or aryl diisocyanates generates polycarbonates having alkyl, aryl, and urethane groups, or urea groups. Addition of dicarboxylic acids, tricarboxylic acids, or, for example, dimethyl terephthalate or tricarboxylic esters can produce ester groups.

Subsequent functionalization can be obtained by using an additional step (step c)) to react the resultant high-functionality hyperbranched polycarbonate with a suitable functionalizing reagent, which can react with the OH and/or carbonate groups, or carbamoyl groups, of the polycarbonate.

High-functionality hyperbranched polycarbonates comprising hydroxy groups can by way of example be modified via addition of molecules comprising acid groups or of molecules comprising isocyanate groups. By way of example, polycarbonates comprising acid groups can be obtained via reaction with compounds comprising anhydride groups.

High-functionality polycarbonates comprising hydroxy groups can moreover be converted to high-functionality polycarbonate polyether polyols via reaction with alkylene oxides, e.g. ethylene oxide, propylene oxide, or butylene oxide.

The molding compositions of the invention can comprise, as preferred hyperbranched polymer, at least one hyperbranched polyester C2) of AₓB_{y} type, where x is at least 1, in particular at least 1.1, preferably at least 1.3, particularly preferably at least 2, and y is at least 2; in particular at least 2.1, preferably at least 2.5, particularly preferably at least 3.

A polyester of AₓB_{y} type is a condensate which forms from an x-functional molecule A and from a y-functional molecule B. By way of example, mention may be made of a polyester derived from adipic acid as molecule A (x=2) and glycerol as molecule B (y=3).

For the purposes of this invention, hyperbranched polyesters C2) are uncrosslinked macromolecules having hydroxy and carboxy groups and having both structural and molecular nonuniformity. They can firstly be composed of a central molecule by analogy with dendrimers, but with nonuniform chain length of the branches. Secondly, they can also be of linear structure, having functional pendent groups, or else, combining the two extremes, can have linear and branched portions of the molecule.

The Mn of the hyperbranched polyesters C2) is preferably from 300 to 30 000 g/mol, in particular from 400 to 25 000 g/mol, and very particularly from 500 to 20 000 g/mol, determined by means of GPC, PMMA standard, dimethylacetamide eluent.

The hyperbranched polyesters C2) preferably have an OH number of from 0 to 600 mg KOH/g of polyester, preferably from 1 to 500 mg KOH/g of polyester, in particular from 20 to 500 mg KOH/g of polyester, to DIN 53240, and also preferably have a COOH number of from 0 to 600 mg KOH/g of polyester, preferably from 1 to 500 mg KOH/g of polyester, and in particular from 2 to 500 mg KOH/g of polyester. The Tg is preferably from −50° C. to 140° C. and in particular from −50 to 100° C. (by means of DSC, to DIN 53765).

Preference is in particular given to those hyperbranched polyesters C2) in which at least one OH number or COOH number is greater than 0, preferably greater than 0.1, and in particular greater than 0.5.

The preferred hyperbranched polyesters C2) are preferably obtainable by reacting
(a) one or more dicarboxylic acids or one or more derivatives of the same with one or more at least trifunctional alcohols, or
(b) one or more tricarboxylic acids or higher polycarboxylic acids, or one or more derivatives of the same, with one or more diols,
   in the presence of a solvent and optionally in the presence of an inorganic, organometallic, or low-molecular-weight organic catalyst, or of an enzyme. The reaction in a solvent is the preferred method of production.

For the purposes of the present invention, high-functionality hyperbranched polyesters C2) have molecular and structural nonuniformity. By virtue of their molecular nonuniformity, they differ from dendrimers, therefore being considerably easier to produce.

Among the dicarboxylic acids that can be reacted by variant (a) are in particular oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and also cis- and trans-cyclopentane-1,3-dicarboxylic acid, where the abovementioned dicarboxylic acids can have substitution by one or more radicals selected from
C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, or n-decyl,
C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preferably cyclopentyl, cyclohexyl and cycloheptyl;
alkylene groups, such as methylene, or ethylidene, or
C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Suitable representatives that may be mentioned for substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids that can be reacted by variant (a) are also ethylenically unsaturated acids, e.g. maleic acid and fumaric acid, and also aromatic dicarboxylic acids, such as phthalic acid, isophthalic acid, or terephthalic acid. Mixtures of two or more of the abovementioned representatives can also be used. The dicarboxylic acids can be used either as they stand or in the form of derivatives.

Derivatives are preferably
the relevant anhydrides in monomeric or else polymeric form,
mono- or dialkyl esters, preferably mono- or dimethyl esters, or the corresponding mono- or diethyl esters, but also the mono- and dialkyl esters derived from higher alcohols, such as n-propanol, isopropanol, n-butanol, isobutanol, tert-butanol, n-pentanol, n-hexanol, and also
mono- and divinyl esters, and also
mixed esters, preferably methyl ethyl esters.

For the purposes of the preferred production process it is also possible to use a mixture of a dicarboxylic acid and of one or more derivatives thereof. It is equally possible to use a mixture of a plurality of various derivatives of one or more dicarboxylic acids.

It is particularly preferable to use succinic acid, glutaric acid, adipic acid, phthalic acid, isophthalic acid, terephthalic acid, or mono- or dimethyl esters thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (b) are benzene-1,2,4-tricarboxylic acid, benzene-1,3,5-tricarboxylic acid, benzene-1,2,4,5-tetracarboxylic acid, and mellitic acid. Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else
mono-, di-, or trivinyl esters
and mixed methyl ethyl esters.

For the purposes of the present invention, it is also possible to use a mixture composed of a tri- or polycarboxylic acid and one or more of its derivatives. For the purposes of the present invention it is likewise possible to use a mixture of two or more different derivatives of one or more tri- or polycarboxylic acids, in order to obtain component C2).

Examples of diols used for variant (b) of the preferred process are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethyl-pentane-2,4-diol, 2-ethylhexane-1,3-diol, 2,5-dimethylhexane-2,5-diol, 2,2,4-trimethyl-pentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds of the above compounds, where n is an integer and n=from 4 to 25. One, or else both, hydroxy groups here in the abovementioned diols may also be replaced by SH groups. Preference is given to ethylene glycol, propane-1,2-diol, and diethylene glycol, triethylene glycol, dipropylene glycol, and tripropylene glycol.

The molar ratio of the molecules A to molecules B in the AₓB_{y} polyester in the variants (a) and (b) is from 4:1 to 1:4, in particular from 2:1 to 1:2.

The at least trihydric alcohols reacted according to variant (a) of the process may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (a) may also have hydroxy groups having at least two different chemical reactivities.

The different reactivity of the functional groups here may derive either from chemical causes (e.g. primary/secondary/tertiary OH group) or from steric causes. By way of example, the triol may comprise a triol which has primary and secondary hydroxy groups, a preferred example being glycerol.

When the inventive reaction is carried out according to variant (a), it is preferable to operate in the absence of diols and of monohydric alcohols. When the inventive reaction is carried out according to variant (b), it is preferable to operate in the absence of mono- or dicarboxylic acids.

The production of the hyperbranched polyesters C2) preferred in the present invention is known and is disclosed by way of example in WO 2007/074687, on page 24, line 37 to page 28, line 33, the content of which is expressly incorporated herein by way of reference.

The molar mass Mw of the preferred hyperbranched polyesters C2) is from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They usually have good solubility, i.e. clear solutions can be prepared at up to 50% by weight, indeed in some instances up to 80% by weight, of the polyesters of the invention in tetrahydrofuran (THF), n-butyl acetate, ethanol, and numerous other solvents, without any gel particles detectable by the naked eye.

The high-functionality hyperbranched polyesters C2) are preferably carboxy-terminated, or terminated by carboxy and hydroxy groups, and particularly preferably terminated by hydroxy groups.

When hyperbranched polymers of type C1) and C2) are used in a mixture, the ratio by weight of component C1) to C2) is preferably from 1:20 to 20:1, in particular from 1:15 to 15:1, and very particularly from 1:5 to 5:1.

The hyperbranched polycarbonates C1) and polyesters C2) used are respectively preferably particles of size from 20 to 500 nm, in particular from 30 to 400 nm, very particularly preferably from 50 to 300 nm. These nanoparticles are present in finely dispersed form within the polymer blend, and the size of the particles within the compounded material is from 20 to 500 nm, preferably from 50 to 300 nm.

Component D

The thermoplastic molding compositions preferably comprise at least one functionalized polyarylene ether comprising carboxy groups, in particular those with intrinsic viscosity to DIN EN ISO 1628-1 of from 45 to 65 ml/g, measured in 1% strength by weight solution in N-methyl-2-pyrrolidone at 25° C. The intrinsic viscosity to DIN EN ISO 1628-1 of the functionalized polyarylene ethers of component (D), measured in 1% strength by weight solution in N-methyl-2-pyrrolidone at 25° C., is preferably at least 46 ml/g, particularly preferably at least 47 ml/g, in particular at least 48 ml/g. Component D therefore differs from component A in particular in that component D, unlike component A, has functionalization by carboxy groups.

The use of polyarylene ethers comprising carboxy groups with intrinsic viscosity to DIN EN ISO 1628-1 of more than 65 ml/g, measured in 1% strength by weight solution in N-methyl-2-pyrrolidone at 25° C. generally leads to a disadvantageous reduction in flowability, without any further improvement in mechanical properties. Accordingly, the intrinsic viscosity to DIN EN ISO 1628-1 of the polyarylene ethers of component (D) is preferably subject to an upward restriction and is preferably at most 65 ml/g, particularly preferably at most 61 ml/g, in particular at most 57 ml/g, in each case measured in 1% strength by weight solution in N-methyl-2-pyrrolidone at 25° C.

In thermal plastic molding compositions based on polyarylene ethers and on polyarylene sulfides comprising particulate or fibrous fillers in combination with component (C) of the invention, an intrinsic viscosity within the stated range leads to improved mechanical properties and to particularly advantageous flowability. Without any intended restriction, it is believed that the chemical structure and defined intrinsic viscosity of the functionalized polyarylene ethers of component (D) lead to synergistic action of these with the fillers, in particular glass fibers.

The thermoplastic molding compositions of the invention preferably comprise, as component (D) at least one functionalized polyarylene ether which comprises units of the general formula I as defined for the purposes of component (A1) and, respectively, (A2), and also units of the general formula IV:

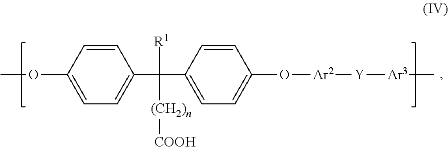

in which
n is 0, 1, 2, 3, 4, 5, or 6;
R¹ is hydrogen, a C₁-C₆-alkyl group, or —(CH₂)ₙ—COOH;
Ar² and Ar³ can be identical or different and are independently of one another a C₆-C₁₈-arylene group, and
Y is a chemical bond or a group selected from —O—, —S—, —SO₂—, S═O, C═O, —N═N—, and —CR^{a}R^{b}—, where R^{a} and R^{b} can be identical or non-identical, and independently of one another are in each case a hydrogen atom or a C₁-C₁₂-alkyl, C₁-C₁₂-alkoxy, or C₆-C₁₈-aryl group.

It is preferable that the proportion of units of the general formula IV, based on the entirety of the units according to formula I and formula IV, is from 0.5 to 3 mol %, preferably from 0.6 to 2 mol %, with particular preference from 0.7 to 1.5 mol %.

For the purposes of the present invention, the proportion of units of the general formula IV, based on the entirety of the units according to formula I and formula IV, is in principle determined by means of ¹H NMR spectroscopy, using a defined amount of 1,3,5-trimethoxybenzene as internal standard. The person skilled in the art knows how to convert % by weight to mol %.

For the purposes of the general formula IV, it is preferable that n=2 and that R¹=methyl. For the purposes of the general formula IV, it is moreover preferable that Ar²═Ar³=1,4-phenylene, and that Y═—SO₂—.

The functionalized polyarylene ethers (component D) used in the molding compositions of the invention are compounds known per se or can be produced by known processes.

By way of example, the functionalized polyarylene ethers of component (D) are obtainable by a method based on EP-A-0 185 237, or else by the processes described by I. W. Parsons et al., in Polymer, 34, 2836 (1993) and T. Koch, H. Ritter, in Macromol. Phys. 195, 1709 (1994).

The polyarylene ethers are accordingly in particular obtainable via polycondensation of compounds of the general formula V:

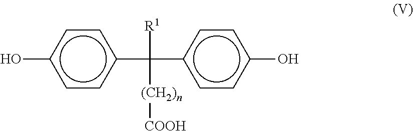

in which R¹ and n are defined as above, with at least one further aromatic compound reactive toward the compounds of the general formula V, a particular example being 4,4′-dichlorodiphenyl sulfone, and optionally with further hydroxy-functionalized compounds, e.g. bisphenol A and/or bisphenol S, and/or 4,4′-dihydroxybiphenyl. Suitable reactants are well known to the person skilled in the art.

Production of the functionalized polyarylene ethers of component (D) can in principle also use the methods used for polyarylene ethers of component (A1), and preference is likewise given to the solution polymerization process in dipolar aprotic solvents, with involvement of base.

The statements made in relation to component (A1) in respect of preferred structural elements of the general formula I apply correspondingly to the functionalized polyarylene ethers of component (D).

In particular, it is preferable that the polyarylene ethers of components (A1) and (D) are structurally similar, in particular being based on the same monomer units, and differing merely in relation to the units of the general formula IV for the purposes of component (D). It is particularly preferable that both component (A1) and component (D) are based on units of the PESU type as defined above, or that both component (A1) and component (D) are based on units of the PPSU type as defined above, or that both component (A1) and component (D) are based on units of the PSU type as defined above. “Are based on” in this context means that both component (A1) and component (D) are composed of the same units, differing merely in that component (D) has additional functionalization, preferably comprising monomer units of the general formula IV as defined above. It is particularly preferable that the polyarylene ethers of component (A1) and the functionalized polyarylene ethers of component (D) in each case comprise the same units of the general formula I.

For the purposes of the general formula IV, particularly suitable units are:

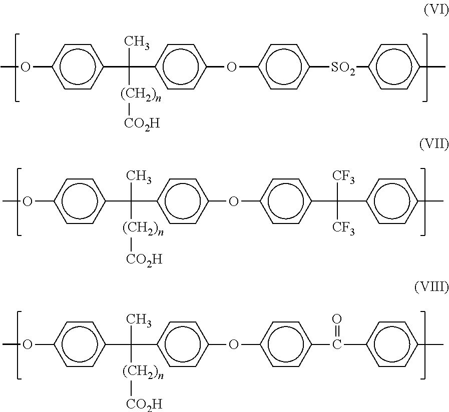

in which n is in each case an integer from 0 to 4. Very particular preference is given to the unit VI.

Component E

The thermoplastic molding compositions of the present invention comprise, as component (E), at least one fibrous or particulate filler, the preferred amount of which is from 5 to 70% by weight, particularly preferably from 15 to 70% by weight, in particular from 15 to 65% by weight, based on a total of 100% by weight of components (A) to (F).

The molding compositions of the invention can in particular comprise particulate or fibrous fillers, particular preference being given to fibrous fillers.

Preferred fibrous fillers are carbon fibers, potassium titanate whiskers, aramid fibers, and particularly preferably glass fibers. If glass fibers are used, these can have been equipped with a size, preferably with a polyurethane size, and with a coupling agent, to improve compatibility with the matrix material. The diameter of the carbon fibers and glass fibers used is generally in the range from 6 to 20 μm. Component (E) is therefore particularly preferably composed of glass fibers.

The form in which glass fibers are incorporated can either be that of short glass fibers or else that of continuous-filament fibers (rovings). The average length of the glass fibers in the finished injection molding is preferably in the range from 0.08 to 0.5 mm.

Carbon fibers or glass fibers can also be used in the form of textiles, mats, or glass-silk rovings.

Suitable particulate fillers are amorphous silica, carbonates, such as magnesium carbonate and chalk, powdered quartz, mica, various silicates, such as clays, muscovite, biotite, suzoite, tin maletite, talc, chlorite, phlogopite, feldspar, calcium silicates, such as wollastonite, or aluminum silicates, such as kaolin, particularly calcined kaolin.

Preferred particulate fillers are those in which at least 95% by weight, preferably at least 98% by weight, of the particles have a diameter (greatest diameter through the geometric center), determined on the finished product, of less than 45 μm, preferably less than 40 μm, where the value known as the aspect ratio of the particles is in the range from 1 to 25, preferably in the range from 2 to 20, determined on the finished product. The aspect ratio is the ratio of particle diameter to thickness (greatest dimension to smallest dimension, in each case through the geometric center).

The particle diameters can by way of example be determined here by recording electron micrographs of thin layers of the polymer mixture and evaluating at least 25 filler particles, preferably at least 50. The particle diameters can also be determined by way of sedimentation analysis, as in Transactions of ASAE, page 491 (1983). Sieve analysis can also be used to measure the proportion by weight of the fillers with diameter less than 40 μm.

The particulate fillers used particularly preferably comprise talc, kaolin, such as calcined kaolin, or wollastonite, or a mixture of two or all of said fillers. Among these, particular preference is given to talc having a proportion of at least 95% by weight of particles with diameter smaller than 40 μm and with aspect ratio of from 1.5 to 25, in each case determined on the finished product. Kaolin preferably has a proportion of at least 95% by weight of particles with diameter smaller than 20 μm and preferably has an aspect ratio of from 1.2 to 20, which in each case is determined on the finished product.

The thermoplastic molding compositions can moreover comprise further additives and/or processing aids as component F.

Component F

The molding compositions of the invention can comprise, as constituents of component (F), auxiliaries, in particular processing aids, pigments, stabilizers, flame retardants, or a mixture of various additives. Other examples of conventional additives are oxidation retarders, agents to counteract decomposition by heat and decomposition by ultraviolet light, lubricants and mold-release agents, dyes and plasticizers.

The proportion of component (F) in the molding composition of the invention is in particular from 0 up to 30% by weight, preferably from 0 up to 20% by weight, in particular from 0 to 15% by weight, based on the total weight of components (A) to (E). If component E includes stabilizers, the proportion of said stabilizers is usually up to 2% by weight, preferably from 0.01 to 1% by weight, in particular from 0.01 to 0.5% by weight, based on the total of the % by weight values for components (A) to (E).

The amounts generally comprised of pigments and dyes are from 0 to 6% by weight, preferably from 0.05 to 5% by weight, and in particular from 0.1 to 3% by weight, based on the total of the % by weight values for components (A) to (F).

Pigments for the coloring of thermoplastics are well known, see for example R. Gachter and H. Müller, Taschenbuch der Kunststoffadditive [Plastics additives handbook], Carl Hanser Verlag, 1983, pages 494 to 510. A first preferred group of pigments that may be mentioned are white pigments, such as zinc oxide, zinc sulfide, white lead [2PbCO₃.Pb(OH)₂], lithopones, antimony white, and titanium dioxide. Of the two most familiar crystalline forms of titanium dioxide (rutile and anatase), it is in particular the rutile form which is used for white coloring of the molding compositions of the invention. Black color pigments which can be used according to the invention are iron oxide black (Fe₃O₄), spinell black [Cu(Cr, Fe)₂O₄], manganese black (a mixture composed of manganese dioxide, silicon dioxide, and iron oxide), cobalt black, and antimony black, and also particularly preferably carbon black, which is mostly used in the form of furnace black or gas black. In this connection see G. Benzing, Pigmente für Anstrichmittel [Pigments for paints], Expert-Verlag (1988), pages 78 ff.

Particular color shades can be achieved by using inorganic chromatic pigments, such as chromium oxide green, or organic chromatic pigments, such as azo pigments or phthalocyanines. Pigments of this type are known to the person skilled in the art.

Examples of oxidation retarders and heat stabilizers which can be added to the thermoplastic molding compositions according to the invention are halides of metals of group I of the Periodic Table of the Elements, e.g. sodium halides, potassium halides, or lithium halides, examples being chlorides, bromides, or iodides. Zinc fluoride and zinc chloride can moreover be used. It is also possible to use sterically hindered phenols, hydroquinones, substituted representatives of said group, secondary aromatic amines, optionally in combination with phosphorus-containing acids, or to use their salts, or a mixture of said compounds, preferably in concentrations up to 1% by weight, based on the total of the % by weight values for components (A) to (F).

Examples of UV stabilizers are various substituted resorcinols, salicylates, benzotriazoles, and benzophenones, the amounts generally used of these being up to 2% by weight.

Lubricants and mold-release agents, the amounts of which added are generally up to 1% by weight, based on the total of the % by weight values for components (A) to (F), are stearyl alcohol, alkyl stearates, and stearamides, and also esters of pentaerythritol with long-chain fatty acids. It is also possible to use dialkyl ketones, such as distearyl ketone.

The molding compositions of the invention comprise, as preferred constituent, from 0.1 to 2% by weight, preferably from 0.1 to 1.75% by weight, particularly preferably from 0.1 to 1.5% by weight, and in particular from 0.1 to 0.9% by weight (based on the total of the % by weight values for components (A) to (F)) of stearic acid and/or stearates. Other stearic acid derivatives can in principle also be used, examples being esters of stearic acid.

Stearic acid is preferably produced via hydrolysis of fats. The products thus obtained are usually mixtures composed of stearic acid and palmitic acid. These products therefore have a wide softening range, for example from 50 to 70° C., as a function of the constitution of the product. Preference is given to products with more than 20% by weight content of stearic acid, particularly preferably more than 25% by weight. It is also possible to use pure stearic acid (>98%).

Component (F) can moreover also include stearates. Stearates can be produced either via reaction of corresponding sodium salts with metal salt solutions (e.g. CaCl₂, MgCl₂, aluminum salts) or via direct reaction of the fatty acid with metal hydroxide (see for example Baerlocher Additives, 2005). It is preferable to use aluminum tristearate.

Further additives that can be used are also those known as nucleating agents, an example being talc.

Components (A) to (F) can be mixed in any desired sequence.

The molding compositions of the invention can be produced by processes known per se, for example extrusion. The molding compositions of the invention can by way of example be produced by mixing the starting components in conventional mixing apparatuses, such as screw-based extruders, preferably twin-screw extruders, Brabender mixers, or Banbury mixers, or else kneaders, and then extruding them. The extrudate is cooled and comminuted. The sequence of the mixing of the components can be varied, and it is therefore possible to mix two or more than two components in advance, but it is also possible to mix all of the components together.

In order to obtain a mixture with maximum homogeneity, intensive and thorough mixing is advantageous. Average mixing times needed for this are generally from 0.2 to 30 minutes at temperatures of from 290 to 380° C., preferably from 300 to 370° C. The extrudate is generally cooled and comminuted.

The thermoplastic molding compositions of the invention can be used advantageously for producing moldings, fibers, foams, or films. The molding compositions of the invention are particularly suitable for producing moldings for household items, or for electrical or electronic components, as well as for producing moldings for the vehicle sector, and in particular automobiles.

The examples below provide further explanation of the invention without restricting the same.

### EXAMPLES

The moduli of elasticity, ultimate tensile strength, and tensile strain at break of the specimens were determined on dumbbell specimens in the ISO 527 tensile test.

The impact resistance of the products comprising glass fibers was determined on ISO specimens to ISO 179 1eU. The notched impact resistance of the unreinforced products was determined to ISO 179 1eB. In the case of the unreinforced products, tensile strength to ISO 527 was determined instead of ultimate tensile strength.

Flowability was assessed on the basis of melt viscosity. Melt stability was determined by means of a capillary rheometer. Apparent viscosity was determined here at 350° C. as a function of shear rate in a capillary viscometer (Göttfert Rheograph 2003 capillary viscometer) with a circular capillary of length 30 mm, with radius 0.5 mm, with a nozzle angle of 180°, with a diameter of 12 mm for the melt reservoir vessel, and with a preheating time of 5 minutes. The values determined at 1000 Hz are stated.

Anisotropy of stiffness was determined as follows, on sheets: sheets of dimensions 150*150*3 mm³ were produced in a mold with film gate. Said sheets were used in each case to produce 5 tensile specimens on a high-speed cutter. The test specimens were cut either in the direction of flow (direction y) or perpendicularly thereto (direction x). Said test specimens were used for determination of modulus of elasticity in the direction of flow and perpendicularly to the direction of flow.

The intrinsic viscosity of the polyarylene ethers was determined in 1% strength N-methylpyrrolidone solution at 25° C. to DIN EN ISO 1628-1.

Component A1

Component A1-1 used was a PESU-type polyether sulfone with intrinsic viscosity of 49.0 ml/g (Ultrason® E 1010 from BASF SE). The product used had 0.16% by weight of Cl end groups and 0.21% by weight of OCH₃ end groups.

Component A2

Component A2-1 used was a polyether sulfone with intrinsic viscosity of 55.6 ml/g, which had 0.20% by weight of OH end groups and 0.02% by weight of Cl end groups.

Component B

Component B-1 used was a polyphenylene sulfide with melt viscosity of 145 Pa*s at 330° C. using a shear rate of 1000 Hz.

Component C

Component C-1 used was a hyperbranched polycarbonate produced as follows:

The polyfunctional alcohol, diethyl carbonate, and 0.15% by weight of potassium carbonate as catalyst (amount based on amount of alcohol) were used as initial charge in accordance with the batch quantities of table 1 in a three-necked flask equipped with stirrer, reflux condenser, and internal thermometer, and the mixture was heated to 140° C. and stirred at this temperature for 2 h. As reaction time proceeded, the temperature of this reaction mixture decreased, the reason for this being the onset of evaporated cooling by the ethanol liberated. The reflux condenser was then replaced by an inclined condenser, and based on the equivalent amount of catalyst, one equivalent of phosphoric acid was added, ethanol was removed by distillation, and the temperature of the reaction mixture was increased slowly to 160° C. The alcohol removed by distillation was collected in a cooled round-bottomed flask and weighed, and conversion was thus determined and compared in percentage terms with the full conversion theoretically possible (see table 1).

Dry nitrogen was then passed at 160° C. through the reaction mixture for a period of 1 h, in order to remove any residual amounts of monomers present. The reaction mixture was then cooled to room temperature.

Analysis of the polycarbonates of the invention:

The polycarbonates were analyzed by gel permeation chromatography using a refractometer as detector. The mobile phase used was dimethylacetamide, and the standard used for molecular weight determination was polymethyl methacrylate (PMMA).

OH number was determined to DIN 53240, part 2.

TABLE 1
Starting materials and final products

| | | | Molar mass | OH number of |
|---|---|---|---|---|
| | Molar | Distillate, amount of | of product | product |
| | ratio of | alcohol, based on | (g/mol) | (mg KOH/g) |
| | alcohol to | complete conversion | Mw | to DIN 53240, |
| Alcohol | carbonate | mol % | Mn | part 2 |
| TMP × | 1:1 | 72 | 2300 | 400 |
| 1.2 PO | | | 1500 | |

TMP = Trimethylolpropane
PO = Propylene oxide

The expression “TMP×1.2 PO” here describes a product which, per mole of trimethylolpropane, has been reacted with an average of 1.2 mol of propylene oxide.

Component D

Component D-1 used was a functionalized polyether sulfone, produced as follows:

577.03 g of dichlorodiphenyl sulfone, 495.34 g of dihydroxydiphenyl sulfone, and 5.73 g of 4,4′-bishydroxyphenylvaleric acid (“DPA”) were dissolved in 1053 ml of NMP under nitrogen, and 297.15 g of anhydrous potassium carbonate were admixed. The reaction mixture was heated to 190° C. and kept at this temperature for 6 h. The mixture was then diluted with 1947 ml of NMP. After cooling to T<80° C., the suspension was discharged. Filtration was then used to remove the insoluble constituents. The resultant solution was then precipitated in water. The resultant white powder was then repeatedly extracted with hot water and then dried in vacuo at 140° C. The proportion of DPA units was determined by means of ¹H NMR spectroscopy using 1,3,5-trimethoxybenzene as internal standard as 0.9 mol %, and the intrinsic viscosity of the product was 46.9 ml/g.

Component E

Chopped glass fibers with staple length 4.5 mm and fiber diameter 10 μm were used as component E-1, and had been provided with a polyurethane size.

TABLE 2
Properties of the blends made of polyarylene ethers and
of polyarylene sulfides, comprising glass fibers. The
constitution of the thermoplastic molding compositions is
stated in parts by weight (comp = comparative example,
n.d. = not determined).

| | Example | | | | | | |
|---|---|---|---|---|---|---|---|
| | comp 1 | 2 | 3 | comp 4 | 5 | 6 | comp 7 |
| Component | 41 | 40.3 | 40 | 36 | 35.3 | 32.8 | 36 |
| A1-1 | | | | | | | |
| Component | — | — | — | — | — | 2.5 | 5 |
| A2-1 | | | | | | | |
| Component | 14 | 13.7 | 13.5 | 14 | 13.7 | 13.7 | 14 |
| B-1 | | | | | | | |
| Component | — | 1 | 1.5 | — | 1 | 1 | — |
| C-1 | | | | | | | |
| Component | — | — | — | 5 | 5 | 5 | — |
| D-1 | | | | | | | |
| Component E-1 | 45 | 45 | 45 | 45 | 45 | 45 | 45 |
| Modulus of | 16.5 | 16.9 | 17.1 | 16.5 | 17.2 | 17.1 | 16.5 |
| elasticity [GPa] | | | | | | | |
| Tensile strain | 1.4 | 1.6 | 1.7 | 1.9 | 2.0 | 2.1 | 1.5 |
| at break [%] | | | | | | | |
| Ultimate tensile | 148 | 161 | 162 | 161 | 167 | 169 | 152 |
| strength [MPa] | | | | | | | |
| ISO 179 | 42 | 48 | 49 | 52 | 53 | 58 | 44 |
| 1eU [kJ/m²] | | | | | | | |
| Viscosity at | 554 | 487 | 423 | 567 | 479 | 414 | 562 |
| 1000 Hz | | | | | | | |
| (350° C.) | | | | | | | |
| Modulus of | 12.6 | 14.1 | 14.3 | 12.7 | 13.9 | 14.0 | 12.7 |
| elasticity of | | | | | | | |
| sheet (flow | | | | | | | |
| direction y) | | | | | | | |
| [GPa] | | | | | | | |
| Modulus of | 7.9 | 9.7 | 10.3 | 8.2 | 9.8 | 9.9 | 7.9 |
| elasticity of | | | | | | | |
| sheet (flow | | | | | | | |
| direction x) | | | | | | | |
| [GPa] | | | | | | | |

As shown in table 2, the molding compositions of the invention feature improved flowability at the same time as good mechanical properties. The molding compositions of the invention in particular have high stiffness, the anisotropy of which has been reduced. There is moreover an improvement in impact resistance.

TABLE 3
Properties of the blends made of polyarylene ethers and
of polyarylene sulfides. The constitution of the thermoplastic
molding compositions is stated in parts by weight.

| | Example | |
|---|---|---|
| | Comp 8 | 9 |
| Component A1-1 | 80 | 79.2 |
| Component A2-1 | — | — |
| Component B-1 | 20 | 19.8 |
| Component C-1 | — | 1 |
| Component D-1 | — | — |
| Component E-1 | — | — |
| Modulus of elasticity [GPa] | 2.85 | 2.84 |
| Tensile strain at break [%] | >40 | >40 |
| Ultimate tensile strength/Tensile strength [MPa] | 82.1 | 82.3 |
| ISO 179 1 eB [kJ/m²] | 34 | 92 |
| Viscosity at 1000 Hz (350° C.) | 217 | 167 |

In comparison with the prior art, the unreinforced molding compositions of the invention have markedly improved flowability, and they also have markedly improved notched impact resistance.

1. A thermoplastic molding composition comprising the following components:
(A1) at least one polyarylene ether having an average of at most 0.5 phenolic end groups per polymer chain,
(A2) optionally at least one polyarylene ether having an average of at least 1.5 phenolic end groups per polymer chain,
(B) at least one polyarylene sulfide,
(C) at least one hyperbranched polymer selected from hyperbranched polycarbonates and hyperbranched polyesters,
(D) optionally at least one functionalized polyarylene ether comprising carboxy groups,
(E) optionally at least one fibrous or particulate filler, and
(F) optionally further additives and/or processing aids.

2. The thermoplastic molding composition according to claim 1, comprising from 20 to 89.9% by weight of component (A1), from 0 to 10% by weight of component (A2), from 5 to 65% by weight of component (B), from 0.1 to 5% by weight of component (C), from 0 to 15% by weight of component (D), from 5 to 70% by weight of component (E), and from 0 to 40% by weight of component (F), where the total of the % by weight values for components (A) to (F), based on the entire amount of components (A) to (F), is 100% by weight.

3. The thermoplastic molding composition according to claim 1, comprising from 20 to 83.9% by weight of component (A1), from 1 to 10% by weight of component (A2), from 5 to 65% by weight of component (B), from 0.1 to 5% by weight of component (C), from 0 to 15% by weight of component (D), from 10 to 70% by weight of component (E) and from 0 to 40% by weight of component (F), where the total of the % by weight values for components (A) to (F), based on the entire amount of components (A) to (F), is 100% by weight.

4. The thermoplastic molding composition according to claim 1, where the polyarylene ethers (A1) have an average of at most 0.1 phenolic end groups per polymer chain and the polyarylene ethers (A2) have an average of at least 1.8 phenolic end groups per polymer chain.

5. The thermoplastic molding composition according to claim 1, where component (C) comprises at least one hyperbranched polycarbonate having an OH number of from 1 to 600 mg KOH/g of polycarbonate to DIN 53240.

6. The thermoplastic molding composition according to claim 1, where component (C) comprises at least one hyperbranched polyester of AₓB_{y} type, where x is at least 1 and y is at least 2.

7. The thermoplastic molding composition according to claim 1, where the polyarylene ethers of components (A1) and optionally (A2) are, independently of one another, composed of units of the general formula I: 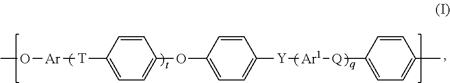
where the definitions are as follows:
t and q independently of one another 0, 1, 2, or 3,
Q,T and Y: independently of one another in each case a chemical bond or group selected from —O—, —S—, —SO₂—, S═O, C═O, —N═N—, and —CR^{a}R^{b}—, where R^{a} and R^{b} independently of one another are in each case a hydrogen atom or a C₁-C₁₂-alkyl, C₁-C₁₂-alkoxy, or C₆-C₁₈-aryl group, and where at least one of Q, T, and Y is —SO₂—, and
Ar and Ar¹: independently of one another a C₆-C₁₈-arylene group.

8. The thermoplastic molding composition according to claim 7, where the polyarylene ethers (A1) and (A2) are composed of the same units according to the general formula I.

9. The thermoplastic molding composition according to claim 7, where Q, T, and Y in formula (I) have been selected independently of one another from —O— and —SO₂—, and at least one of Q, T, and Y is —SO₂—.

10. The thermoplastic molding composition according to claim 7, where Ar and Ar¹ in formula (I) have been selected independently of one another from the group consisting of 1,4-phenylene, 1,3-phenylene, naphthylene, and 4,4′-bisphenylene.

11. The thermoplastic molding composition according to claim 1, comprising, as component (D), at least one functionalized polyarylene ether comprising carboxy groups with intrinsic viscosity to DIN EN ISO 1628-1 of from 45 to 65 ml/g, measured in 1% strength by weight solution in N-methyl-2-pyrollidone at 25° C.

12. The thermoplastic molding composition according to claim 7, where the functionalized polyarylene ether comprising carboxy groups comprises units of the general formula I, and also units of the general formula IV: 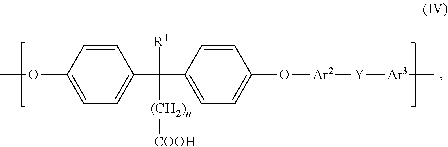
in which
n is an integer from 0 to 6, and
R¹ is H, C₁ to C₆-alkyl, or —(CH₂)ₙ—COOH
Ar² and Ar³ independently of one another are a C₆-C₁₈-arylene group, and
Y is a chemical bond or a group selected from —O—, —S—, —SO₂—, S═O, C═O, —N═N—, and —CR^{a}R^{b}—, where R^{a} and R^{b} independently of one another are in each case a hydrogen atom or a C₁-C₁₂-alkyl, C₁-C₁₂-alkoxy, or C₆-C₁₈-aryl group.

13. The thermoplastic molding composition according to claim 12, where the proportion of units according to the general formula (IV), based on the entirety of the units according to formula (I) and formula (IV), is from 0.5 to 2 mol %.

14. The thermoplastic molding composition according to claim 12, where n=2 and R¹=methyl.

15. The thermoplastic molding composition according to claim 12, where Ar²═Ar³=1,4-phenylene and Y═—SO₂—.

16. The thermoplastic molding composition according to claim 1, where the polyarylene sulfides of component (B) are composed of from 30 to 100% by weight of repeat units of the general formula —Ar—S—, where —Ar— is an arylene group having from 6 to 18 carbon atoms.

17. The thermoplastic molding composition according to claim 1, where component (B) is polyphenylene sulfide.

18. The thermoplastic molding composition according to claim 1, where component (D) is composed of glass fibers.

19. A process for producing thermoplastic molding compositions according to claim 1, comprising mixing of components (A) to (F) in a mixing apparatus.

20. (canceled)

21. A molding, a fiber, a foam, or a film comprising thermoplastic molding compositions according to claim 1.

22. The thermoplastic molding composition according to claim 1, where component (B) is poly(1,4-phenylene sulfide).
